(19) United States
(12) Patent Application Publication
(10) Pub. No.: US 2025/0087874 A1
(43) Pub. Date: Mar. 13, 2025

(54) VEHICULAR ANTENNA DEVICE

(71) Applicant: YOKOWO CO., LTD., Chiyoda-ku, Tokyo (JP)

(72) Inventors: Hiroto IEDA, Tomioka-Shi, Gunma (JP); Kazuhiro KOWAITA, Tomioka-Shi, Gunma (JP); Takashi KANEKO, Tomioka-Shi, Gunma (JP)

(73) Assignee: YOKOWO CO., LTD., Chiyoda-ku, Tokyo (JP)

(21) Appl. No.: 18/284,533

(22) PCT Filed: Mar. 11, 2022
(86) PCT No.: PCT/JP2022/011078

§ 371 Date: Sep. 28, 2023

(30) Foreign Application Priority Data
Mar. 29, 2021 (JP) 2021-054757

(51) Int. Cl. H01Q 1/32; H01Q 5/10; H01Q 5/314

(52) U.S. Cl. CPC H01Q 1/3275; H01Q 5/10; H01Q 5/314

(57) ABSTRACT

A vehicular antenna device includes: a first antenna configured to support radio waves in a first frequency band; and a second antenna configured to support radio waves in a second frequency band different from the first frequency band. Further, at least part of an element included in the second antenna resonates in the first frequency band.

### TECHNICAL FIELD

The present disclosure relates to a vehicular antenna device.

### BACKGROUND ART

Patent Literature 1 discloses a vehicular antenna device in which a planar antenna for GPS signals and an AM/FM antenna are housed in an antenna case.

### CITATION LIST

### Patent Literature

[PTL 1] Japanese Patent Application Publication No. 2010-21856

### SUMMARY OF INVENTION

### Technical Problem

It is difficult to ensure directivity needed for a planar antenna, depending on a configuration of a vehicular antenna device.

The present disclosure is directed to, for example, easily controlling the directivity of the planar antenna. The present disclosure is directed also to other which will become apparent from the description of this specification.

### Solution to Problem

An aspect of the present disclosure is a vehicular antenna device comprising: a first antenna configured to support radio waves in a first frequency band; and a second antenna configured to support radio waves in a second frequency band different from the first frequency band, wherein at least part of an element included in the second antenna resonates in the first frequency band.

### Advantageous Effects of Invention

According to an aspect of the present disclosure, it is possible to easily control directivity of a planar antenna.

### BRIEF DESCRIPTION OF DRAWINGS

FIG. 1 is a diagram illustrating a configuration of a vehicular antenna device 10.

FIG. 2 is an exploded perspective view of a patch antenna 30.

FIG. 3A is a perspective view of a metal body 60A and FIG. 3B is a side view of the metal body 60A.

FIG. 4 is a diagram illustrating a configuration of a vehicular antenna device 10X.

FIG. 5 is a graph illustrating an example of a relationship between an elevation angle of the patch antenna 30 and an average gain in the vehicular antenna devices 10 and 10X.

FIG. 6 is an explanatory diagram of a separation distance D and a separation distance H between the patch antenna 30 and a resonator 61.

FIGS. 7A and 7B are graphs illustrating an example of a relationship between the separation distance D and the average gain and a relationship between the separation distance H and the average gain, respectively.

FIGS. 8A to 8C are diagrams illustrating resonators 61A to 61C according to modified examples, respectively.

FIGS. 9A and 9B are diagrams illustrating resonators 61D and 61E according to modified examples, respectively.

FIGS. 10A and 10B are diagrams illustrating resonators 61F and 61G according to modified examples, respectively.

FIGS. 11A and 11B are diagrams illustrating a configuration of a vehicular antenna device 80A, FIG. 11A is a perspective view of the vehicular antenna device 80A, and FIG. 11B is a side view of the vehicular antenna device 80A.

FIGS. 12A and 12B are diagrams illustrating configurations of vehicular antenna devices 80B and 80C, respectively, FIG. 12A is a side view of the vehicular antenna device 80B, and FIG. 12B is a side view of the vehicular antenna device 80C.

FIG. 13 is a diagram illustrating a configuration of a vehicular antenna device 80X.

FIGS. 14A and 14B are each a graph illustrating characteristics of the patch antenna 30 in the vehicular antenna devices 80C and 80X, FIG. 14A illustrating an example of a relationship between an elevation angle and an average gain, and FIG. 14B illustrating an example of directivity at the elevation angle of 20°.

FIG. 15 is an explanatory diagram of a separation distance D between the patch antenna 30 and a resonator 91.

FIG. 16 is a graph illustrating an example of a relationship between the elevation angle and the average gain when the separation distance D is changed.

FIGS. 17A to 17D are diagrams illustrating other examples of a positional relationship between the patch antenna 30 and the resonator 61, FIGS. 17A and 17B are a side view and a plan view illustrating a first example of the positional relationship, respectively, and FIGS. 17C and 17D are a side view and a plan view illustrating a second example of the positional relationship, respectively.

### DESCRIPTION OF EMBODIMENTS

At least the following matters will become apparent from the description of the present specification and the accompanying drawings.

With reference to the drawings, preferred embodiments of the present disclosure will be described below. The same or equivalent components, members, and the like illustrated in the drawings are denoted by the same reference numerals, and redundant description thereof is omitted as appropriate.

### Configuration of Vehicular Antenna Device 10 of First Embodiment

### Overview of Configuration

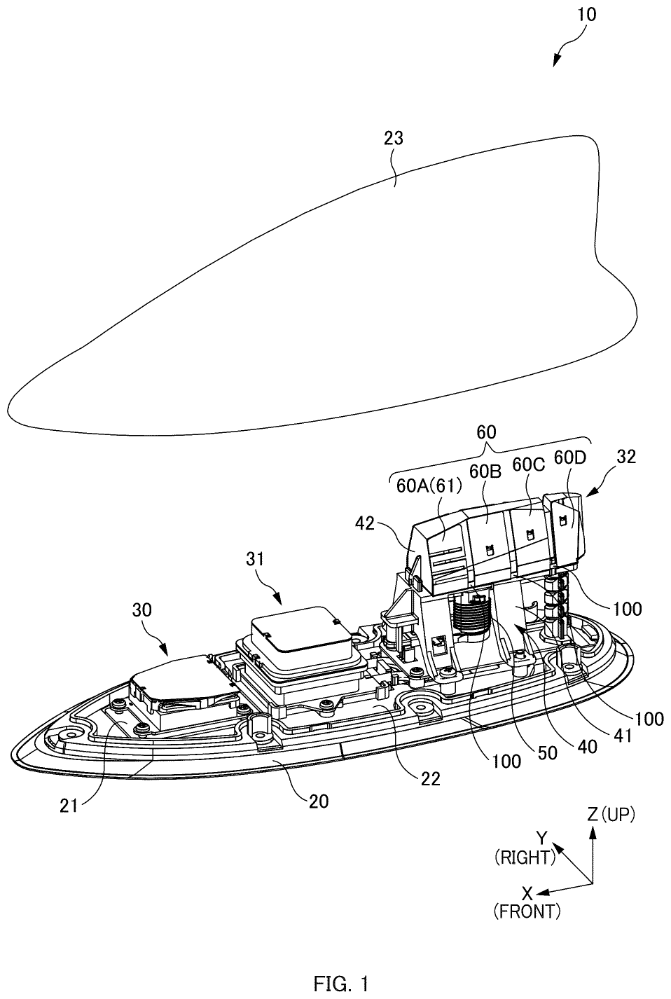

FIG. 1 is a diagram illustrating a configuration of a vehicular antenna device 10 according to a first embodiment. FIG. 1 is a perspective view illustrating the vehicular antenna device 10 with a case 23 removed in a zenith direction (upward direction). First, with reference to FIG. 1, an overview of a configuration of the vehicular antenna device 10 will be described below.

In FIG. 1, it is assumed that a front-rear direction of a vehicle at which the vehicular antenna device 10 is to be mounted is an X direction, a left-right direction perpendicular to the X direction is a Y direction, and a vertical direction perpendicular to the X and Y directions is a Z direction. It is also assumed that, as viewed from a driver's seat of the vehicle, the front side is a +X direction, the right side is a +Y direction, and the zenith direction (upward direction) is a +Z direction. In the following description of an embodiment of the present disclosure, the front-rear, left-right, and up-down directions of the vehicular antenna device 10 are the same as the front-rear, left-right, and up-down directions of the vehicle. Further, viewing the vehicular antenna device 10 in a −Z direction is referred to as “top view”, and viewing the vehicular antenna device 10 in the +Y direction or in a −Y direction is referred to as “side view”.

The definitions of directions and the like described above are common to other embodiments in this specification, unless otherwise specified.

The vehicular antenna device 10 is an antenna device to be attached to a roof on an upper surface of a vehicle (not illustrated). The vehicular antenna device 10 includes an antenna base 20, a case 23, a patch antenna 30, a patch antenna 31, and an antenna 32.

The antenna base 20 is a member forming a bottom surface of the vehicular antenna device 10. The antenna base 20 includes, for example, an insulating base made of resin, a metal base 21, and a metal base 22. The metal bases 21 and 22 are attached to the insulating base with a plurality of screws (not illustrated). However, the insulating base may be formed of a material other than resin as long as the material has insulation properties, and may have a shape other than a plate shape.

The metal base 21 is a member to function as a ground for the vehicular antenna device 10. The metal base 21 is formed in a metal plate shape, for example. However, the metal base 21 may have a shape other than the plate shape, as long as the metal base is a metal member to function as the ground. The patch antenna 30 is installed at the metal base 21.

The metal base 22 is a member to function as a ground for the vehicular antenna device 10. The metal base 22 is formed in a metal plate shape, for example. However, the metal base 22 may have a shape other than the plate shape, as long as the metal base is a metal member to function as the ground. The patch antenna 31 and the antenna 32 are installed at the metal base 22.

In an embodiment of the present disclosure, the metal bases 21 and 22 described above are electrically connected by a metal plate (not illustrated). When mounting the vehicular antenna device 10 at the roof of the vehicle (not illustrated), the metal bases 21 and 22 and the roof are electrically connected. Thus, the metal bases 21 and 22 function as the ground for the vehicular antenna device 10. Although the metal bases 21 and 22 are provided separately in an embodiment of the present disclosure, they may be provided as an integrated metal base. Even when such an integrated metal base is used, the metal base appropriately functions as a ground for the patch antenna 31 and the antenna 32 which will be described later.

In the above description, the antenna base 20 of the vehicular antenna device 10 includes the insulating base and the metal bases 21 and 22, as the member forming the bottom surface of the vehicular antenna device 10 and the member to function as the ground. However, the vehicular antenna device 10 is not limited to such a configuration.

For example, the antenna base 20 may have only the metal bases 21 and 22, or may have only the integrated metal base instead of the metal bases 21 and 22. Further, the antenna base 20 may have the insulating base, the metal base 21, and a metal plate. The vehicular antenna device 10 may have the insulating base and the integrated metal base instead of the metal bases 21 and 22. The vehicular antenna device 10 may have the insulating base, the metal bases 21 and 22, and another metal base, and a metal plate may be used instead of the metal base. Further, the antenna base 20 may have the insulating base and the metal plate.

Accordingly, in the vehicular antenna device 10 according to an embodiment of the present disclosure, the members described above can be freely combined as the member forming the bottom surface of the vehicular antenna device 10 and the member to function as the ground.

The case 23 is a member (housing) to cover the outside of the vehicular antenna device 10. In an embodiment of the present disclosure, the case 23 is a typical shark-fin antenna housing as illustrated in FIG. 1.

The patch antenna 30 is, for example, a planar antenna configured to support radio waves in the 2.3 GHz band of a satellite digital audio radio service (SDARS). In an embodiment of the present disclosure, the patch antenna 30 receives radio waves in the 2.3 GHz band for SDARS. The communication standard and frequency band supported by the patch antenna 30 are not limited to those described above, and other communication standards and frequency bands may be used. Further, the patch antenna 30 may support radio waves in a plurality of frequency bands, and may at least either transmit or receive radio waves in a desired frequency band.

In the following description, the patch antenna 30 may be referred to as “first antenna”. Further, the frequency band of radio waves supported by the patch antenna 30 may be referred to as “first frequency band”.

The patch antenna 30 will be described later in detail.

The patch antenna 31 is, for example, a planar antenna configured to support radio waves in the 1.5 GHz band of a global navigation satellite system (GNSS). In an embodiment of the present disclosure, the patch antenna 31 receives radio waves in the 1.5 GHz band for GNSS. The communication standard and frequency band supported by the patch antenna 31 are not limited to those described above, and other communication standards and frequency bands may be used. Further, the patch antenna 31 may support radio waves in a plurality of frequency bands, and may at least either transmit or receive radio waves in a desired frequency band.

The antenna 32 is, for example, an antenna configured to support radio waves for AM/FM radio. In an embodiment of the present disclosure, the antenna 32 receives AM broadcasting radio waves of 522 kHz to 1710 kHz and FM broadcasting radio waves of 76 MHz to 108 MHz. However, the antenna 32 may receive only either the AM broadcasting radio waves or the FM broadcasting radio waves. The communication standard and frequency band supported by the antenna 32 are not limited to those described above, and other communication standards and frequency bands may be used. Further, the antenna 32 may at least either transmit or receive radio waves in a desired frequency band.

In the following description, the antenna 32 may be referred to as “second antenna”. The frequency band of radio waves supported by the antenna 32 may be referred to as “second frequency band”.

The antenna 32 will be described later in detail.

### Details of Patch Antenna 30 (First Antenna)

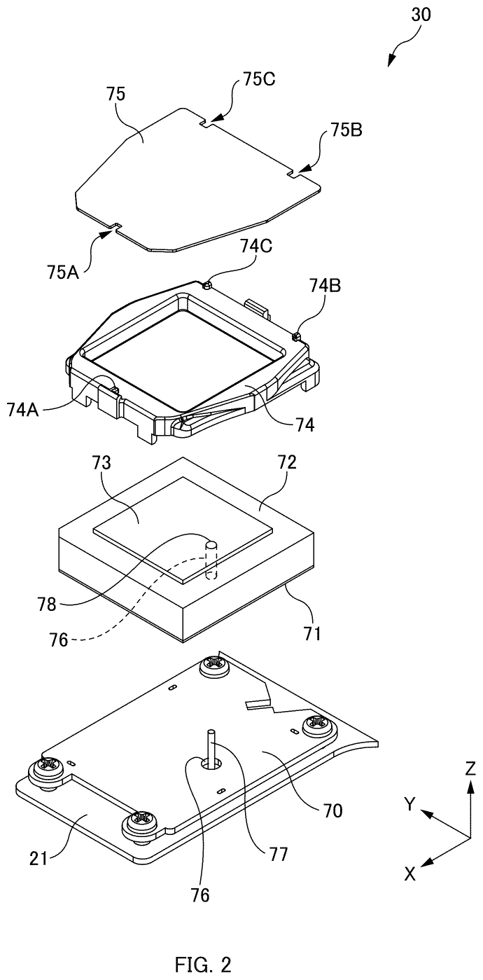

FIG. 2 is an exploded perspective view of the patch antenna 30. With reference to FIG. 2 along with FIG. 1 described above, the patch antenna 30 will be described below in detail.

The patch antenna 30 includes a substrate 70, a dielectric member 72, a radiating element 73, a holding member 74, and a metal body 75.

The substrate 70 is a circuit board at which the dielectric member 72 is provided. As illustrated in FIG. 2, the substrate 70 is attached to the metal base 21.

The dielectric member 72 is a substantially quadrilateral plate-shaped member made of a dielectric material such as ceramic. As illustrated in FIG. 2, front and back surfaces of the dielectric member 72 are parallel to the X and Y directions, the front surface of the dielectric member 72 is oriented in the +Z direction, and the back surface of the dielectric member 72 is oriented in the −Z direction. A pattern 71 is provided at the back surface of the dielectric member 72. The pattern 71 is a conductor to function as a ground conductor film (or ground conductor plate). The back surface of the dielectric member 72 is attached to the substrate 70 with an adhesive (not illustrated), for example.

Here, a “substantially quadrilateral” shape refers to a shape consisting of four sides, including a square and a rectangle, for example, which may have at least a part of corners cut away obliquely with respect to a side, for example. A part of the sides of the “substantially quadrilateral” shape may also include a notch (recessed portion) or a protrusion (protruding portion). The shape of the dielectric member 72 is not limited to the substantially quadrilateral shape, and may be circular or elliptical, for example. The dielectric member 72 may have a shape other than the plate shape.

The radiating element 73 is a conductive substantially quadrilateral member having an area smaller than the area of the front surface of the dielectric member 72. As illustrated in FIG. 2, the radiating element 73 is provided at the front surface of the dielectric member 72. A direction normal to a radiation surface of the radiating element 73 is the +Z direction. The shape of the radiating element 73 is not limited to the substantially quadrilateral shape, and may be circular or elliptical, for example. In other words, the radiating element 73 may have a shape enabling at least either reception or transmission of signals (radio waves) in a desired frequency band.

As illustrated in FIG. 2, the radiating element 73 includes a feed point 78. The feed point 78 is a point at which a feed line 77 illustrated in FIG. 2 is electrically connected to the radiating element 73. In an embodiment of the present disclosure, a configuration including only one single feed line 77 connected to the radiating element 73, that is, a single-feed line system is employed. The radiating element 73 of the single-feed line system has, for example, a substantially rectangular shape whose lengths and widths are different so as to enable at least either transmission or reception of desired circularly polarized waves. The “substantially rectangular” shape is included in the “substantially quadrilateral” shape described above.

However, in an embodiment of the present disclosure, a configuration including two feed lines 77 connected to the radiating element 73, that is, a double-feed line system may be employed. The radiating element 73 of the double-feed line system has, for example, a substantially square shape whose lengths and widths are the same so as to enable transmission and reception of desired circularly polarized waves. The “substantially square” shape is included in the “substantially quadrilateral” shape described above.

In the patch antenna 30 according to an embodiment of the present disclosure, as illustrated in FIG. 2, a through-hole 76 penetrating the substrate 70 and the dielectric member 72 is formed. The through-hole 76 is formed such that the feed line 77 is connected to the radiating element 73 at the feed point 78 thereof. In the radiating element 73 of the double-feed system, two through-holes 76 penetrating the substrate 70 and dielectric member 72 are formed. In each of the through-holes 76, the feed line 77 is connected to the radiating element 73 at the feed point 78 thereof.

The holding member 74 is a member to hold the metal body 75. The holding member 74 is made of resin and provided at the front surface of the dielectric member 72 so as to surround the radiating element 73. However, the holding member 74 may be made of a material other than resin, as long as the holding member can hold the metal body 75. A protruding portion 74A extending in the +Z direction is provided at the side on the +X side, out of the two sides parallel to the Y-axis of the upper surface of the holding member 74, and protruding portions 74B and 74C extending in the +Z direction are provided at the side on the −X side. Each of the protruding portions 74A to 74C is a substantially rectangular parallelepiped protrusion formed to determine the position of the metal body 75 with respect to the holding member 74. However, each of the protruding portions 74A to 74C need not be provided as a substantially rectangular parallelepiped protrusion, as long as the position of the metal body 75 can be determined with respect to the holding member 74. Further, the holding member 74 may not be provided with the protruding portions 74A to 74C. The holding member 74 is not limited to a shape of a frame surrounding the entire circumference of the radiating element 73. For example, a structure in which the metal body 75 is attached to a protrusion provided inside the case 23 may be employed. Alternatively, a structure in which the metal body 75 is fitted in a groove provided inside the case 23 may be employed. That is, the case 23 may have a structure also serving as the holding member 74.

The metal body 75 is a member capacitively connected with the radiating element 73, to thereby improve radiation efficiency of the patch antenna 30 and control the directivity. The metal body 75 is a substantially square zenith plate (or zenith capacitance plate) held by the holding member 74. A recessed portion 75A is provided at the side on the +X side out of the two sides parallel to the Y-axis, and recessed portions 75B and 75C are provided at the side on the −X side. In an embodiment of the present disclosure, the metal body 75 is placed at the front surface of the holding member 74, with the protruding portions 74A to 74C of the holding member 74 being fitted in the recessed portions 75A to 75C of the metal body 75, respectively. However, when the holding member 74 is not provided with the protruding portions 74A to 74C, the metal body 75 may not include the recessed portions 75A to 75C.

Although the metal body 75 has a substantially square plate shape, the shape is not limited thereto and may be a substantially quadrilateral shape other than the substantially square shape, or may be circular or elliptical. The metal body 75 may also have a three-dimensional shape obtained by bending a plate-shaped metal plate. The metal body 75 may be formed in an inverted V shape, an inverted U shape, a mountain shape (umbrella shape) or an arch shape by bending a metal plate, for example. The metal body 75 may also have a shape other than a plate shape.

### Details of Antenna 32 (Second Antenna)

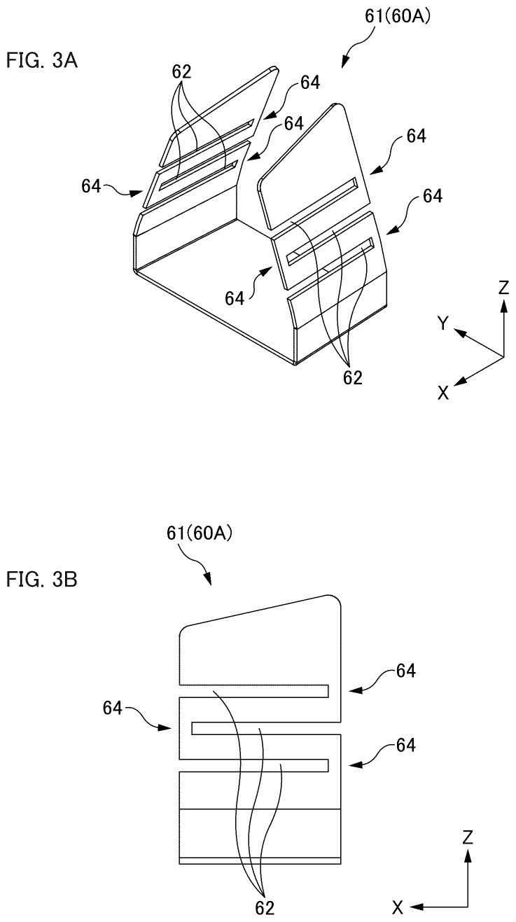

FIG. 3A is a perspective view of a metal body 60A of a capacitive loading element 60 which will be described later. FIG. 3B is a side view of the metal body 60A of the capacitive loading element 60 which will be described later. The antenna 32 will be described below in detail with reference to FIGS. 3A and 3B along with FIG. 1 described above.

The antenna 32 includes a holder 40, a helical element 50, the capacitive loading element 60, and a filter 100.

The holder 40 is a member to hold the helical element 50 and the capacitive loading element 60. The holder 40 is provided at the antenna base 20 as illustrated in FIG. 1. The holder 40 is made of resin, for example. However, the holder 40 may be made of a material other than resin, as long as the holder 40 can hold the helical element 50 and the capacitive loading element 60.

The holder 40 includes a post part 41 and a mounting part 42, as illustrated in FIG. 1. The post part 41 is a part at which the helical element 50 is attached. The mounting part 42 is a part at which the capacitive loading element 60 is mounted. The mounting part 42 whose longitudinal direction is the X direction has a substantially trapezoidal cross-section with a width in the left-right direction increasing downward (−Z direction). However, the shape of the mounting part 42 is not limited to the shape having the substantially trapezoidal cross-section described above. For example, the cross-sectional shape of the mounting part 42 when viewed from the front or rear may be a substantially quadrilateral shape such as a substantially square or substantially rectangular shape. Further, the external shape of the mounting part 42 when viewed from the front or rear may be an inverted V shape, an inverted U shape, a mountain shape (umbrella shape), or an arch shape.

The helical element (hereinafter simply referred to as “coil”) 50 is configured to resonate in a desired frequency band, with the capacitive loading element 60. As illustrated in FIG. 1, the coil 50 is provided above the metal base 22 while being attached to the post part 41 of the holder 40. The coil 50 has one end to be electrically connected to the metal base 22 and the other end to be electrically connected to the capacitive loading element 60.

The capacitive loading element 60 is configured to resonate in a desired frequency band, with the coil 50. As illustrated in FIG. 1, the capacitive loading element 60 includes four metal bodies 60A to 60D obtained by dividing it thereinto along the front-rear direction (longitudinal direction). In the following description, the term “metal body” refers to one formed by processing a metal member, including a metal member having a three-dimensional shape other than a plate shape in addition to a plate-shaped metal member such as a metal plate, for example.

As illustrated in FIGS. 1, 3A, and 3B, each of the metal bodies 60A to 60D according to an embodiment of the present disclosure is formed by bending, upward, two ends in the Y-axis direction of the metal plate at two ends of the bottom surface substantially parallel to the center X-Y plane. In the following description, as for each of the metal bodies 60A to 60D, the bottom portion substantially parallel to the center X-Y plane may be simply referred to as “bottom part”. In addition, the left side of the portion formed by bending upward at two ends of the bottom part may be simply referred to as “left side part” and the right side may be simply referred to as “right side part”. Although FIGS. 3A and 3B illustrate only the metal body 60A among the metal bodies 60A to 60D, the metal bodies 60B to 60D illustrated in FIG. 1 each also have the bottom part, left side part, and right side part as in the metal body 60A.

In an embodiment of the present disclosure, the four metal bodies 60A to 60D have the same lengths in the front-rear direction, but are not limited thereto. For example, the four metal bodies 60A to 60D may have different lengths in the front-rear direction, or some of them may have the same length. The metal bodies 60A to 60D each have the shape with the bottom part, but they may include a metal body without the bottom part.

In an embodiment of the present disclosure, the capacitive loading element 60 includes the four metal bodies 60A to 60D, but is not limited thereto. For example, the capacitive loading element 60 may have one single metal body or may have a plurality of metal bodies other than four. The capacitive loading element 60 has a shape obtained by being bent upward at two ends of the central bottom surface, but the shape is not limited thereto. For example, the capacitive loading element 60 may have a shape obtained by being bent downward from two ends. Further, the external shape of the capacitive loading element 60 when viewed from the front or rear may be, for example, an inverted V shape, an inverted U shape, a mountain shape (umbrella shape) or an arch shape.

The filter 100 is a member configured to electrically connect the four metal bodies 60A to 60D and has a high impedance in the radio wave frequency band supported by the patch antennas 30 and 31. In an embodiment of the present disclosure, three filters 100 are provided. As illustrated in FIG. 1, these three filters 100 are provided in a gap between the metal bodies 60A and 60B in the left side part, in a gap between the metal bodies 60B and 60C in the left side part, and in a gap between the metal bodies 60C and 60D in the left side part, respectively. The filter 100 is, for example, a circuit resonates in parallel in the radio wave frequency band supported by the patch antennas 30 and 31, and includes a capacitor and a coil (not illustrated).

The installation positions and the number of the filters 100 in an embodiment of the present disclosure are not limited to those illustrated in FIG. 1. The filter 100 may be disposed at any position, as long as it is a position at which metal bodies immediately adjacent to each other among the metal bodies 60A to 60D are connected to each other. Thus, the filter 100 may be provided, for example, at an upper position including the top parts of the metal bodies 60A to 60D or at a lower position including the bottom parts thereof. The filter 100 may also be disposed only in the right side part of the capacitive loading element 60. The filters 100 may be alternately disposed in the left side part and the right side part of the capacitive loading element 60.

As described above, the four metal bodies 60A to 60D are electrically connected through the filters 100 having a high impedance in the radio wave frequency band supported by the patch antennas 30 and 31. The coil 50 is designed to have a high impedance in the radio wave frequency band supported by the patch antennas 30 and 31.

Since the filter 100 has a low impedance in the AM/FM frequency band, the entire metal bodies 60A to 60D operate as one single conductor with the coil 50 in the AM/FM frequency band. That is, the coil 50 and the capacitive loading element 60 operate as an antenna configured to resonate in the FM frequency band. In the following description, a member provided to resonate in a desired frequency band in the vehicular antenna device 10 may be referred to as “device” or “element”.

### Resonator 61

The vehicular antenna device 10 according to an embodiment of the present disclosure described above is a so-called composite antenna device including the patch antennas 30 and 31 and the antenna 32. In such a composite antenna device, it is needed to ensure characteristics needed for each antenna while considering electrical interference among the antennas. With the vehicular antenna device 10 according to an embodiment of the present disclosure described above, for example, in the patch antenna 30, it is possible to adjust the sizes and positions of elements (for example, the dielectric member 72, the radiating element 73, and the like) to ensure needed directivity while considering electrical interference with other antennas.

However, the case 23 of the vehicular antenna device 10 has a limited internal space, and thus, for example, in the patch antenna 30, there are limitations in securing the needed directivity by adjusting the sizes and positions of the elements. Thus, the vehicular antenna device 10 capable of easily controlling the directivity of the patch antenna 30 will be described below.

As described above, the capacitive loading element 60 including the metal body 60A resonates with the coil 50 in the FM frequency band (second frequency band). In an embodiment of the present disclosure, the capacitive loading element 60 is provided with the resonator 61 as illustrated in FIGS. 1, 3A, and 3B. The resonator 61 is a portion configured to resonate in the radio wave frequency band (first frequency band) supported by the patch antenna 30 (first antenna). In an embodiment of the present disclosure, the entire metal body 60A functions as the resonator 61. Accordingly, the metal body 60A is one of the elements of the antenna 32 (second antenna) configured to support the radio waves in the AM/FM frequency band (second frequency band), and includes the resonator 61 to resonate in the radio wave frequency band (first frequency band) supported by the patch antenna 30 (first antenna).

In an embodiment of the present disclosure, the resonator 61 is formed to have an electrical length to resonate in the radio wave frequency band (first frequency band) supported by the patch antenna 30 (first antenna). For example, the resonator 61 is formed to have an electrical length corresponding to ½ of the wavelength of the first frequency band. Here, “½ of the wavelength of the first frequency band” is not limited to an exact value, and may be any value as long as it is a value to resonate in a desired frequency band. This is because the wavelength of the first frequency band is not necessarily represented by a divisible integer, and the actual electrical length of the resonator 61 varies due to various factors. The resonator 61 does not have to be formed to have an electrical length corresponding to ½ of the wavelength of the first frequency band, as long as it is formed to resonate in the first frequency band.

As illustrated in FIGS. 3A and 3B, slits 62 are included in the metal body 60A. The slit 62 is a cut (gap) formed so as to extend inward from the outer edge of the metal body 60A. As illustrated in FIG. 3B, three slits 62 are arranged in the Z direction in the left side part of the metal body 60A. The three slits 62 include the slit 62 formed so as to extend in the −X direction, the slit 62 formed so as to extend in the +X direction, and the slit 62 formed so as to extend in the −X direction, in this order when viewed in the +Z direction.

Thus, three turns 64 are included in the left side part of the metal body 60A as illustrated in FIG. 3B. The three turns 64 are included on the +X direction side of the metal body 60A, on the −X direction side of the metal body 60A, and on the +X direction side of the metal body 60A in this order when viewed from the +Z direction. Accordingly, the resonator 61 is formed by repeating the turns 64 in a horizontal direction (that is, in a meandering shape) in the metal body 60A. In an embodiment of the present disclosure, the electrical length to resonate in the first frequency band (for example, the electrical length corresponding to ½ of the wavelength of the first frequency band) can be set by adjusting the horizontal length of the slit 62.

The number, positions, extending directions, and the like of the slits 62 are not limited to those illustrated in FIGS. 3A and 3B. For example, one single slit 62 may be included in the metal body 60A. In this case, one single turn 64 results in being included in the metal body 60A. Alternatively, for example, a plurality of slits 62 other than three may be included in the metal body 60A. In this case, turns 64 corresponding to the number of the slits 62 results in being included.

Although the slits 62 are included only in the left side part of the metal body 60A in FIGS. 3A and 3B, the slit(s) 62 may also be provided in the bottom part of the metal body 60A, for example.

In the side view illustrated in FIG. 3B, the extending direction in which the slit 62 extends is not limited to the horizontal direction, but may be the vertical direction. It is assumed here that the “horizontal direction” or “vertical direction” is not limited to an exact direction, but includes directions deviating by a predetermined angle or less. This is because each part (bottom part, left side part, or right side part) of the metal body 60A is not necessarily provided parallel to the “horizontal direction” or “vertical direction”. Although the slits 62 are provided so as to extend along the horizontal direction in FIGS. 3A and 3B, the slits 62 may also be turned in the middle.

Accordingly, as long as the electrical length of the resonator 61 according to an embodiment of the present disclosure is set such that the resonator 61 resonates in the radio wave frequency band (first frequency band) supported by the patch antenna 30 (first antenna), the number, positions, extending directions, and the like of the slits 62 can be freely combined.

The slits 62 are also provided on the right side part of the metal body 60A in the same manner as those on the left side part of the metal body 60A. The number, positions, extending directions, and the like of the slits 62 are the same on the left side part of the metal body 60A and on the right side part of the metal body 60A, as illustrated in FIG. 3A. However, the number, positions, extending directions, and the like of the slits 62 may be different between the left side part of the metal body 60A and the right side part of the metal body 60A.

Although it has been described above that the metal body 60A has the resonator 61, the present disclosure is not limited thereto, as long as at least one of the metal bodies 60A to 60D configuring the capacitive loading element 60 includes the resonator 61. That is, for example, only the metal body 60B may include the resonator 61, or the metal bodies 60C and 60D may include the resonators 61. Further, when the capacitive loading element 60 is one single metal body, this one single metal body may include the resonator 61. Accordingly, any configuration may be made, as long as at least part of the elements included in the antenna 32 (second antenna) resonates in the radio wave frequency band (first frequency band) supported by the patch antenna 30 (first antenna).

### Configuration of Vehicular Antenna Device 10X of Comparative Example

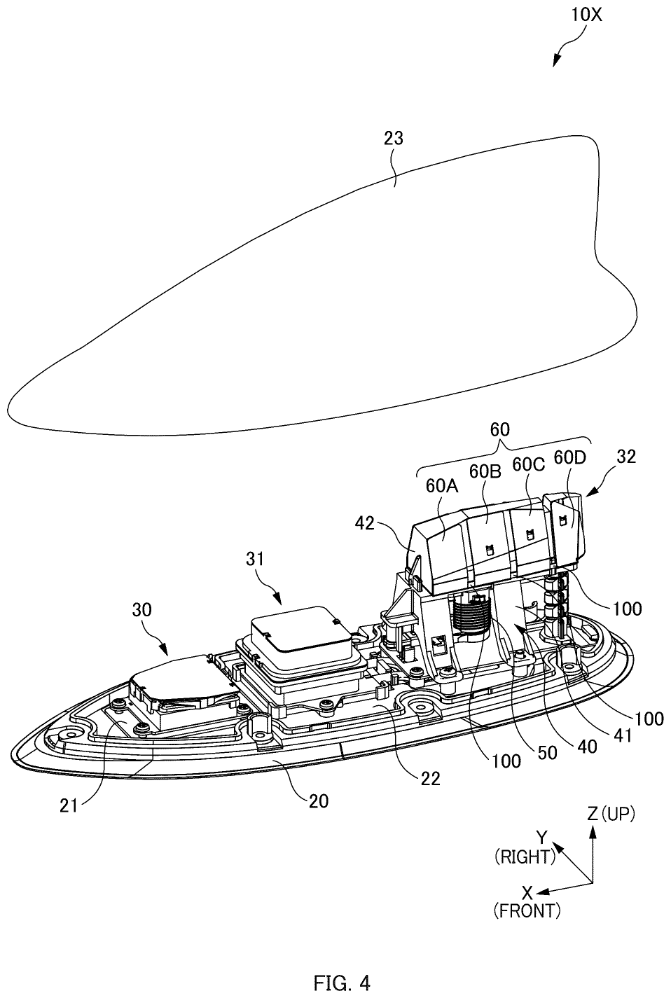

FIG. 4 is a diagram illustrating a configuration of a vehicular antenna device 10X according to a comparative example. The vehicular antenna device 10X is a vehicular antenna device in which a capacitive loading element 60 of an antenna 32 includes no resonator 61. The vehicular antenna device 10X has the same configuration as that of the vehicular antenna device 10 according to an embodiment of the present disclosure described above, except that no resonator 61 is provided.

### Characteristics Comparison Between Vehicular Antenna Devices 10 and 10X

The following describes calculation results of an elevation angle and an average gain of the patch antenna 30 in the vehicular antenna devices 10 and 10X.

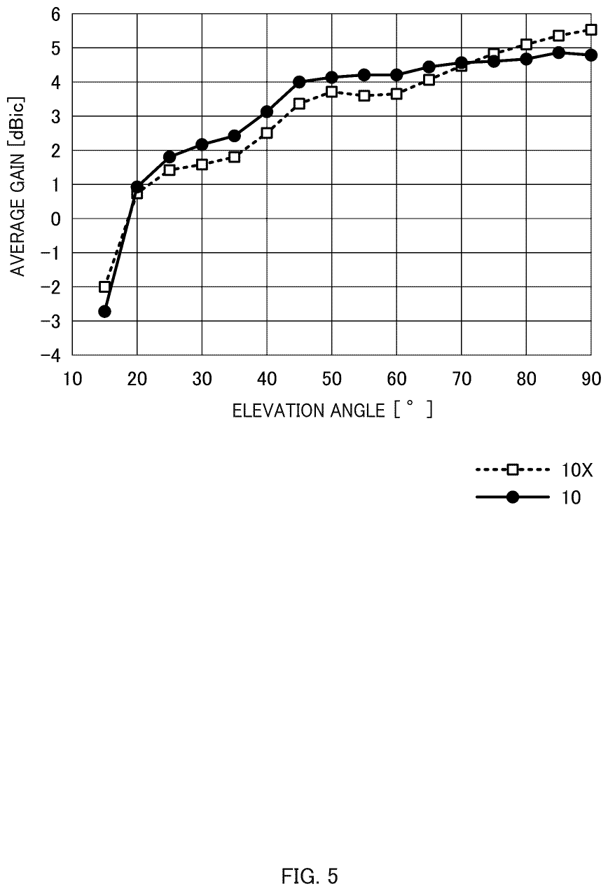

FIG. 5 is a graph illustrating an example of a relationship between the elevation angle of the patch antenna 30 and the average gain in the vehicular antenna devices 10 and 10X. In FIG. 5, the horizontal axis represents the elevation angle and the vertical axis represents the average gain. In FIG. 5, the dashed line depicts the calculation result in the vehicular antenna device 10X, while the solid line depicts the calculation result in the vehicular antenna device 10. Squares, each given a symbol Q, on the dashed line and black circles, each given a symbol *, on the solid line indicate the positions of the numerical values on the vertical axis with respect to the numerical values on the horizontal axis, and these symbols Q and * are used for convenience to differentiate therebetween. In the following description, the average gain may be simply referred to as “gain”.

As illustrated in FIG. 5, when comparing the gain of the vehicular antenna device 10X according to the comparative example with the gain of the vehicular antenna device 10 according to an embodiment of the present disclosure, the gain of the vehicular antenna device 10 according to an embodiment of the present disclosure is higher than the gain of the vehicular antenna device 10X according to the comparative example within the range of 20° to 65°. Accordingly, as an antenna device to receive radio waves transmitted from a satellite, for example, the vehicular antenna device 10 according to an embodiment of the present disclosure has the average gain improved within the range of at least part of the elevation angle from a low elevation angle to a middle elevation angle of the patch antenna 30, and thus has ideal directivity. Here, as to the elevation angle, the horizontal angle is 0° and the zenith angle is 90°. The low elevation angle refers to, for example, the range of 0° to 30°. The medium elevation angle refers to the range of 30° to 60°. The high elevation angle refers to the range of 60° to 90°.

Accordingly, as a result of improving the directivity of the patch antenna 30 in the vehicular antenna device 10, it is possible to efficiently receive incoming radio waves from a satellite, for example. As such, the vehicular antenna device 10 according to an embodiment of the present disclosure includes the resonator 61, thereby being able to easily control the directivity of the patch antenna 30.

The directivity of the patch antenna 30 has been described above. The vehicular antenna device 10 according to an embodiment of the present disclosure can also easily control the directivity of the patch antenna 31 other than the patch antenna 30, by including another resonator 61, although detailed description thereof is omitted. That is, the vehicular antenna device 10 according to an embodiment of the present disclosure can easily control the directivity of planar antennas such as the patch antennas 30 and 31.

### Separation Distance Between Patch Antenna 30 and Resonator

Here, in the top view and side view illustrated in FIG. 1, the patch antenna 30 and the resonator 61 are nonoverlapping. When the patch antenna 30 and the resonator 61 are separated by a predetermined distance in the horizontal direction or the vertical direction, the phase of the radio waves supported by the patch antenna 30 and the phase of the radio waves supported by the antenna 32 provided with the resonator 61 strengthen each other. In the vehicular antenna device 10 according to an embodiment of the present disclosure, the gain of the patch antenna 30 is further improved when there is such a separation distance at which the phases of the radio waves strengthen each other. The following verifies the separation distance at which the phase of the radio waves supported by the patch antenna 30 and the phase of the radio waves supported by the antenna 32 strengthen each other.

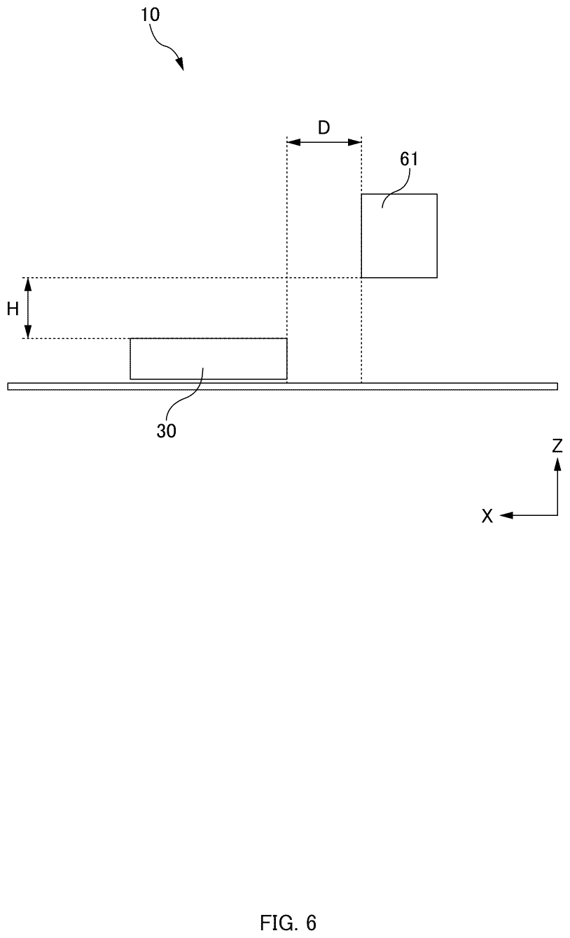

FIG. 6 is an explanatory diagram of a separation distance D and a separation distance H.

The separation distance D is a separation distance in the horizontal direction (X direction) between the patch antenna 30 and the resonator 61 of the antenna 32 in the side view, as illustrated in FIG. 6. To be more specific, the separation distance D is the distance between the end of the patch antenna 30 closest to the resonator 61 and the end of the resonator 61 closest to the patch antenna 30, in the horizontal direction.

The separation distance H is a separation distance in the vertical direction (Z direction) between the patch antenna 30 and the resonator 61 of the antenna 32 in the side view, as illustrated in FIG. 6. To be more specific, the separation distance H is the distance between the end of the patch antenna 30 closest to the resonator 61 and the end of the resonator 61 closest to the patch antenna 30, in the vertical direction.

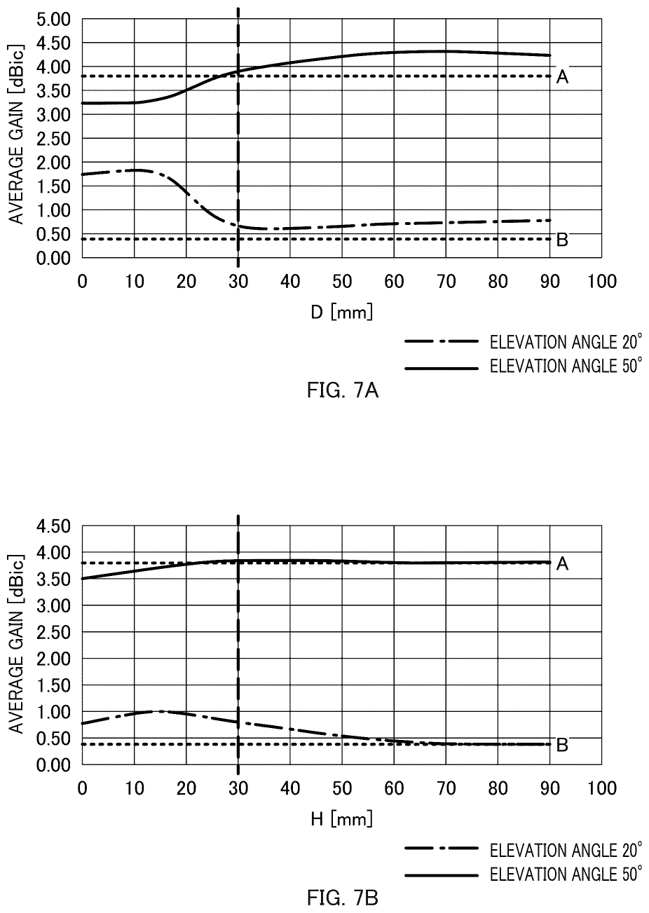

FIG. 7A is a graph illustrating an example of a relationship between the separation distance D and the average gain. FIG. 7B is a graph illustrating an example of a relationship between the separation distance H and the average gain.

In FIG. 7A, the horizontal axis represents the separation distance D and the vertical axis represents the average gain of the patch antenna 30. In FIG. 7B, the horizontal axis represents the separation distance H and the vertical axis represents the average gain of the patch antenna 30. In FIGS. 7A and 7B, the dashed-dotted line indicates a calculation result in the patch antenna 30 at the elevation angle of 20°, and the solid line indicates a calculation result in the patch antenna 30 at the elevation angle of 50°. As a reference of the gain needed for the patch antenna 30, a reference value of the average gain at the elevation angle of 50° is depicted by line A and a reference value of the average gain at the elevation angle of 20° is depicted by line B.

It can be seen, as illustrated in FIG. 7A, that at the elevation angle of 50°, when the separation distance D is equal to or more than 30 mm, the average gain is equal to or greater than the reference value (line A), and the gain needed for the patch antenna 30 can be obtained. When the separation distance D is equal to or more than 30 mm, the average gain is equal to or greater than the reference value (line B) at the elevation angle of 20° as well.

It can be seen, as illustrated in FIG. 7B, that at the elevation angle of 50°, when the separation distance H is equal to or more than 30 mm, the average gain is equal to or greater than the reference value (line A), and the gain needed for the patch antenna 30 can be obtained. When the separation distance D is equal to or more than 30 mm, the average gain is equal to or greater than the reference value (line B) at the elevation angle of 20° as well.

Accordingly, it can be seen from the above that the gain needed for the patch antenna 30 can be obtained by separating the patch antenna 30 and the resonator 61 by a distance equal to or more than 30 mm in the horizontal or the vertical direction. Here, 30 mm corresponds to ¼ of the wavelength of the radio wave frequency band (first frequency band) supported by the patch antenna 30 (first antenna). Accordingly, in the vehicular antenna device 10 according to an embodiment of the present disclosure, it is preferable that the first antenna (patch antenna 30) and the resonator 61 are separated by a distance equal to or more than ¼ of the wavelength of the first frequency band in the horizontal direction or the vertical direction.

Here, “¼ of the wavelength of the first frequency band” is not limited to an exact value, as long as it is a value capable of obtaining the gain needed for the patch antenna 30. This is because the wavelength of the first frequency band is not necessarily represented by a divisible integer, and the actual electrical length of the resonator 61 varies due to various factors. In addition, the desirable separation distance between the patch antenna 30 and the resonator 61 also changes depending on the reference value (line A and line B) of the average gain needed for the patch antenna 30. Thus, the first antenna (patch antenna 30) and the resonator 61 do not have to be separated by a distance equal to or more than ¼ of the wavelength of the first frequency band in the horizontal direction or the vertical direction.

### Modified Example of Resonator 61

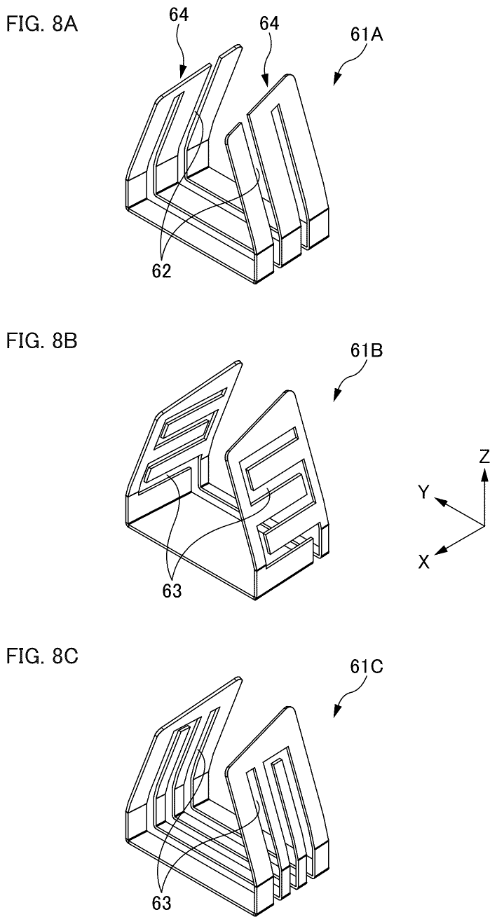

FIGS. 8A to 8C are diagrams illustrating resonators 61A to 61C according to modified examples.

The resonator 61 described above is formed by repeating the turn 64 in the horizontal direction in the metal body 60A. However, the resonator 61 is not limited to this shape. As in a resonator 61A illustrated in FIG. 8A, slits 62 substantially parallel to a Y−Z plane may be provided across the left side part, the bottom part, and the right side part of the metal body 60A.

As illustrated in FIG. 8A, the metal body 60A includes two slits 62 arranged in the X direction. The two slits 62 include the slit 62 formed in the direction from the left side through the bottom side to the right side and the slit 62 formed in the direction from the right side through the bottom side to the left side, when viewed from the −X direction.

This provides two turns 64, as illustrated in FIG. 8A, in the metal body 60A. The two turns 64 are provided in the left side part and the right side part, respectively. Thus, the resonator 61A is formed by repeating the turn 64 in the vertical direction in the metal body 60A. In the resonator 61A, the electrical length to resonate in the first frequency band (for example, the electrical length corresponding to ½ of the wavelength of the first frequency band) can be set, by adjusting the length of the slit 62, for example.

The slits 62 are formed in the resonators 61 and 61A described above. However, the method of forming the resonator with the electrical length to resonate in the first frequency band is not limited to forming the slits 62. Slots 63 may be formed as in resonators 61B and 61C illustrated in FIGS. 8B and 8C. The slot 63 is an opening (hole or gap) formed in the metal body 60A.

As illustrated in FIG. 8B, the resonator 61B includes slots 63 that are repeatedly turned in the horizontal direction in the left side part and right side part of the metal body 60A. The slot 63 in the left side part and the slot 63 in the right side part are connected at the bottom side of the metal body 60A.

As illustrated in FIG. 8C, the resonator 61C has a slot 63 extending across the left side part, the bottom part, and the right side part of the metal body 60A, and the slot 63 is repeatedly turned in the vertical direction.

In the resonator 61B illustrated in FIG. 8B and the resonator 61C illustrated in FIG. 8C, as well, the electrical length to resonate in the first frequency band (for example, the electrical length corresponding to ½ of the wavelength of the first frequency band) can be set, by adjusting the length of the slot 63, for example.

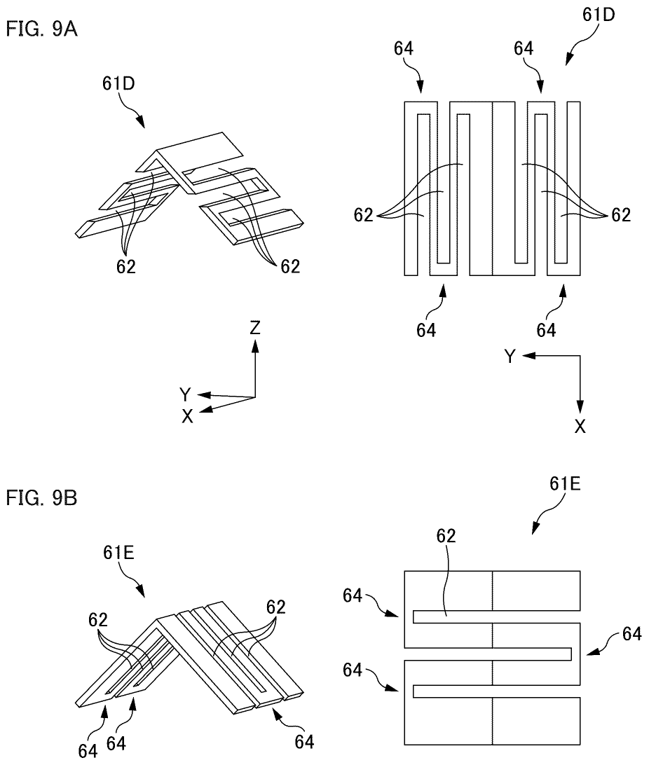

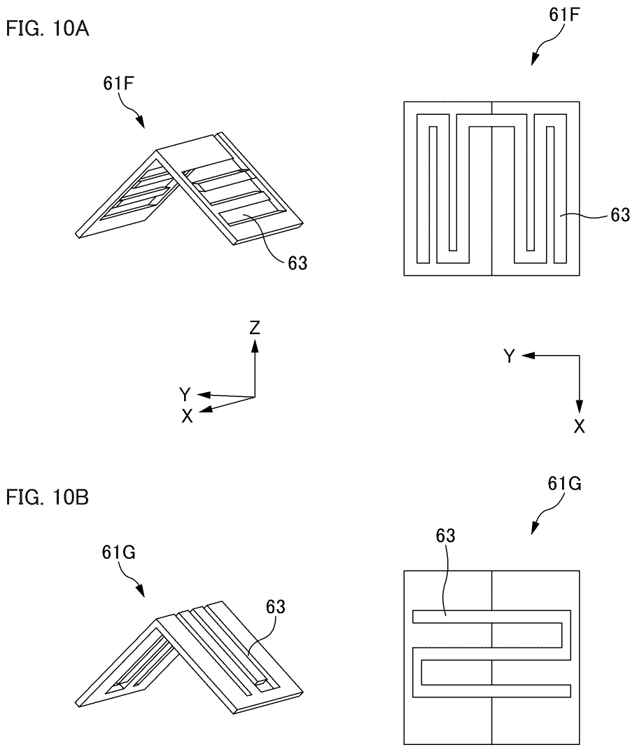

FIGS. 9A and 9B are diagrams illustrating resonators 61D and 61E according to modified examples, respectively. FIGS. 10A and 10B are diagrams illustrating resonators 61F and 61G according to modified examples, respectively.

The resonator 61 and the resonators 61A to 61C described above are provided at the metal body 60A having a shape obtained by being bent upward at two ends of the central bottom surface. However, as in the resonators 61D to 61G illustrated in FIGS. 9A, 9B, 10A, and 10B, the resonator may be provided at a mountain-shaped (umbrella-shaped) metal body. The mountain-shaped (umbrella-shaped) metal body includes a configuration in which the upper edges of the left side part and the right side part are connected to each other and the outer shape of the metal body when viewed from the front or rear is an inverted V shape, an inverted U-shape, an arch shape, or a substantially trapezoidal shape.

The resonator 61D illustrated in FIG. 9A is formed in a mountain-shaped (umbrella-shaped) metal body and is formed by repeating the turn 64 in the horizontal direction by virtue of slits 62. The resonator 61E illustrated in FIG. 9B is formed in a mountain-shaped (umbrella-shaped) metal body and is formed by repeating turn 64 in the vertical direction by virtue of slits 62.

The resonator 61F illustrated in FIG. 10A is formed in a mountain-shaped (umbrella-shaped) metal body and has formed therein a slot 63 obtained by being repeatedly turned in the horizontal direction. The resonator 61G illustrated in FIG. 10B is formed in a mountain-shaped (umbrella-shaped) metal body and has formed therein a slot 63 obtained by being repeatedly turned in the vertical direction.

In the resonators 61D to 61G illustrated in FIGS. 9A to 10B, as well, the electrical length to resonate in the first frequency band (for example, the electrical length corresponding to ½ of the wavelength of the first frequency band) can be set, by adjusting the length of the slit 62 or the slot 63, for example.

In the first embodiment described above, a description has been given of the vehicular antenna device 10, which is a composite antenna device including the patch antenna 30 as the first antenna and the AM/FM radio antenna 32 as the second antenna. To be more specific, the capacitive loading element 60 of the antenna 32 includes the resonator 61 configured to resonate with the coil 50 in the FM frequency band (second frequency band) and further resonate in the radio wave frequency band (first frequency band) supported by the patch antenna 30 (first antenna).

However, the second antenna is not limited to the AM/FM radio antenna, but may be an antenna configured to support other communication standards and frequency bands. For example, the second antenna may be an antenna for telematics, as in vehicular antenna devices 80A to 80C which will be described later.

### Configuration of Vehicular Antenna Devices 80A to 80C of Second Embodiment

### Vehicular Antenna Device 80A of First Example

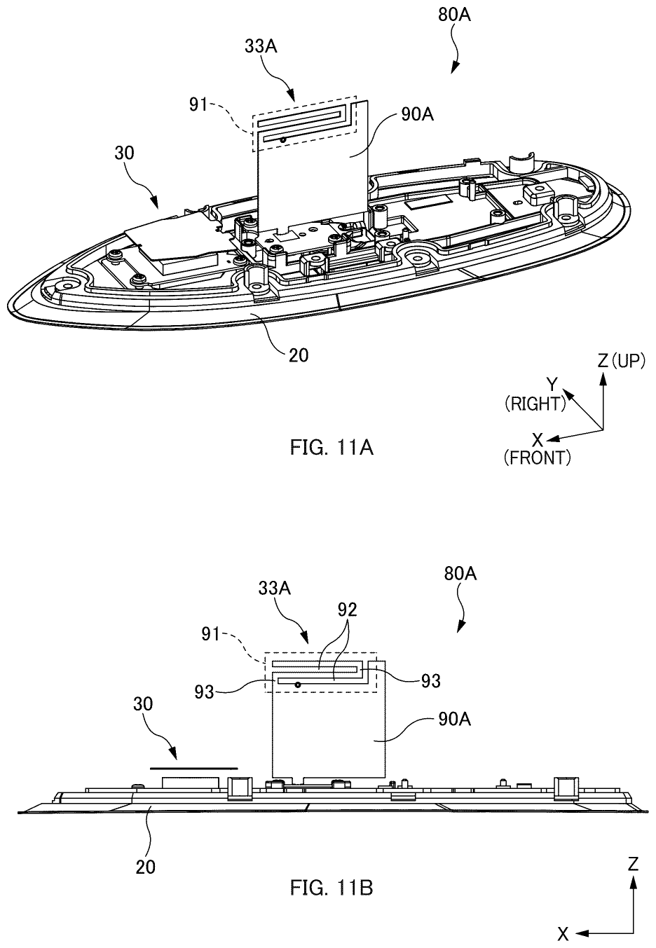

FIGS. 11A and 11B are each a diagram illustrating a configuration of the vehicular antenna device 80A. FIG. 11A is a perspective view of the vehicular antenna device 80A. FIG. 11B is a side view of the vehicular antenna device 80A.

The vehicular antenna device 80A includes an antenna base 20, a patch antenna 30, and an antenna 33A. In an embodiment of the present disclosure, illustration of a member (housing) covering the outside of the vehicular antenna device 80A, that is, a member corresponding to the case 23 in the vehicular antenna device 10 according to the first embodiment illustrated in FIG. 1 is omitted.

The antenna base 20 according to this embodiment of the present disclosure is the same as the antenna base 20 of the vehicular antenna device 10 according to the first embodiment, and thus detailed description thereof is omitted. Further, the patch antenna 30 according to this embodiment of the present disclosure is also the same as the patch antenna 30 of the vehicular antenna device 10 according to the first embodiment, and thus detailed description thereof is omitted. In FIGS. 11A and 11B, illustration of members corresponding to the holding member 74 and the metal body 75 in the patch antenna 30 illustrated in FIG. 2 is omitted.

The antenna 33A is an antenna for telematics. The antenna 33A is an antenna configured to support radio waves in a frequency band from 700 MHz to 2.7 GHz used for long term evolution (LTE), for example, and radio waves in a sub-6 band, that is, in a frequency band from 3.6 GHz to less than 6 GHz used for 5th generation mobile communication system (5G). However, the communication standard and frequency band supported by the antenna 33A are not limited to those described above, but other communication standards and frequency bands may be used.

The antenna 33A may be, for example, an antenna configured to support radio waves in the frequency band used for Vehicle to Everything (V2X: vehicle-to-vehicle communication, road-to-vehicle communication), Wi-Fi (registered trademark), Bluetooth (registered trademark), and DAB. The antenna 33A may also be an antenna for keyless entry or an antenna for smart entry.

The antenna 33A may also be an antenna configured to support multiple-input multiple-output (MIMO) communication. In this case, the vehicular antenna device 80A supports MIMO communication by further including an antenna that is the same as the antenna 33A. The vehicular antenna device 80A configured to perform MIMO communication transmits data from each of a plurality of antennas included in the vehicular antenna device 80A and simultaneously receives data through the plurality of antennas.

Accordingly, the vehicular antenna device 80A according to an embodiment of the present disclosure is a composite antenna device including the patch antenna 30 and the antenna 33A. Such a vehicular antenna device 80A can also easily control the directivity of the patch antenna 30 by including a resonator 91 which will be described later, as in the case of the vehicular antenna device 10 according to the first embodiment.

Unlike the vehicular antenna device 10 according to the first embodiment, the antenna 33A of the vehicular antenna device 80A may be referred to as “second antenna” in the following description. In addition, the radio wave frequency band supported by the antenna 33A may be referred to as “second frequency band”.

The antenna 33A (second antenna) includes an element 90A configured to resonate in the radio wave frequency band (second frequency band) supported by the antenna 33A. The element 90A includes the resonator 91 as illustrated in FIGS. 11A and 11B. The resonator 91 is a portion configured to resonate in the radio wave frequency band (first frequency band) supported by the patch antenna 30 (first antenna). In an embodiment of the present disclosure, part of the element 90A formed in a meandering shape functions as the resonator 91 as depicted by the dashed lines in FIGS. 11A and 11B. Accordingly, the resonator 91 is the part of the element 90A of the antenna 33A (second antenna) configured to support the radio waves in the frequency band (second frequency band) for telematics, and resonates in the radio wave frequency band (first frequency band) supported by the patch antenna 30 (first antenna).

To be more specific, the electrical length of the resonator 91 is set so as to resonate in the radio wave frequency band (first frequency band) supported by the patch antenna 30 (first antenna). For example, the resonator 91 is formed to have an electrical length corresponding to ¼ of the wavelength of the first frequency band. Here, “¼ of the wavelength of the first frequency band” is not limited to an exact value, but may be any value as long as it is a value to resonate in a desired frequency band. This is because the wavelength of the first frequency band is not necessarily represented by a divisible integer, and the actual electrical length of the resonator 91 varies due to various factors. The electrical length of the resonator 91 does not have to correspond to ¼ of the wavelength of the first frequency band, as long as the electrical length is set such that the resonator resonates in the first frequency band.

As illustrated in FIG. 11B, slits 92 are included in the element 90A. The slits 92 are cuts (gaps) formed so as to extend inward from the outer edge of the element 90A. The element 90A includes two slits 92 as illustrated in FIG. 11B. In the side view illustrated in FIG. 11B, the two slits 92 include the slit 92 formed so as to extend in the −X direction and the slit 92 formed so as to extend in the −Z direction from the upper end of the element 90A and then be turned and extend in the +X direction.

Thus, as illustrated in FIG. 11B, two turns 93 are included in the part of the element 90A. The two turns 93 are provided on the +X direction side of the element 90A and on the −X direction side of the element 90A, respectively, in the order when viewed from the +Z direction. Accordingly, the resonator 91 is formed by repeating the turn 93 in the horizontal direction in the element 90A (that is, in a meandering shape). In an embodiment of the present disclosure, the electrical length to resonate in the first frequency band (for example, the electrical length corresponding to ¼ of the wavelength of the first frequency band) can be set, by adjusting the horizontal lengths of the slits 92, for example.

The number, positions, extending directions, and the like of the slits 92 are not limited to those illustrated in FIG. 11B. For example, one single slit 92 may be included in the element 90A. In this case, the slit 92 includes one single turn 93. Alternatively, for example, the element 90A may further include the slit(s) 92 in addition to these two slits. In this case, the turns 93 corresponding to the number of the slits 92 results in being included.

Further, in the side view illustrated in FIG. 11B, the direction in which the slits 92 extend is not limited to the horizontal direction, but may be the vertical direction. Although one of the slits 92 turns in the middle in FIG. 11B, the slits may extend along the horizontal direction only. The resonator 91 may also be formed by repeating the turn in the vertical direction in the element 90A. Furthermore, in the element 90A, (a) slot(s) may be formed instead of the slit(s).

Accordingly, as long as the electrical length of the resonator 91 according to an embodiment of the present disclosure is set such that the resonator resonates in the radio wave frequency band (first frequency band) supported by the patch antenna 30 (first antenna), the number, positions, extending directions, and the like of the slit(s) 92 or slot(s) described above can be freely combined.

As long as the resonator 91 resonates in the first frequency band, part of the element 90A is formed in the meandering shape. For example, in vehicular antenna devices 80B and 80C which will be described later, the width of an element of an antenna is set to a predetermined length to resonate in the first frequency band.

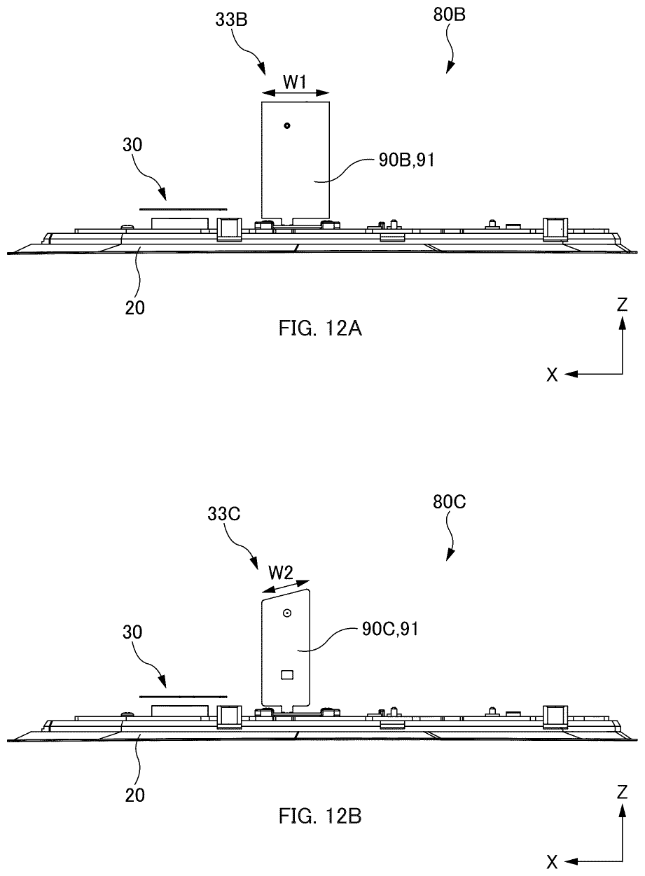

FIGS. 12A and 12B are diagrams illustrating configurations of the vehicular antenna devices 80B and 80C, respectively. FIG. 12A is a side view of the vehicular antenna device 80B, and FIG. 12B is a side view of the vehicular antenna device 80C.

### Vehicular Antenna Device 80B of Second Example

The vehicular antenna device 80B includes an antenna base 20, a patch antenna 30, and an antenna 33B, which is an antenna for telematics. The vehicular antenna device 80B has the same configuration as that of the vehicular antenna device 80A, except that the shape of the antenna 33B is different from the shape of the antenna 33A in the vehicular antenna device 80A described above. Thus, only the antenna 33B will be described below in detail.

In the following description, the antenna 33B of the vehicular antenna device 80B may be referred to as “second antenna”. Further, the frequency band of the radio waves supported by the antenna 33B may be referred to as “second frequency band”.

The antenna 33B (second antenna) has an element 90B configured to resonate in the radio wave frequency band (second frequency band) supported by the antenna 33B. In the vehicular antenna device 80B, a width W1 of the element 90B is set to an electrical length corresponding to ¼ of the wavelength of the radio wave frequency band (first frequency band) supported by the patch antenna 30 (first antenna). Thus, part of the element 90B functions as a resonator 91 configured to resonate in the first frequency band. Accordingly, the resonator 91 is the part of the element 90B of the antenna 33B (second antenna) configured to support radio waves in the frequency band (second frequency band) for telematics, and resonates in the radio wave frequency band (first frequency band) supported by the patch antenna 30 (first antenna).

The element 90B of the antenna 33B, which is the antenna for telematics, is not limited to the shape illustrated in FIG. 12A, but may have other shapes, as illustrated in FIG. 12B.

### Vehicular Antenna Device 80C of Third Example

The vehicular antenna device 80C includes an antenna base 20, a patch antenna 30, and an antenna 33C, which is an antenna for telematics. The vehicular antenna device 80C has the same configuration as that of the vehicular antenna device 80B, except that the shape of the antenna 33C is different from the shape of the antenna 33B in the vehicular antenna device 80B described above. Thus, only the antenna 33C will be described below in detail.

In the following description, the antenna 33C of the vehicular antenna device 80C may be referred to as “second antenna”. Further, the frequency band of the radio waves supported by the antenna 33C may be referred to as “second frequency band”.

The antenna 33C includes an element 90C configured to resonate in the radio wave frequency band (second frequency band) supported by the antenna 33C (second antenna). The element 90C of the antenna 33C has its upper end formed so as to extend obliquely as compared with the element 90B of the antenna 33B illustrated in FIG. 12A.

In the vehicular antenna device 80C, a width W2 of the element 90C is set to an electrical length corresponding to ¼ of the wavelength of the radio wave frequency band (first frequency band) supported by the patch antenna 30 (first antenna). Thus, part of the element 90C functions as a resonator 91 configured to resonate in the first frequency band. Accordingly, the resonator 91 is part of the element 90C of the antenna 33C (second antenna) configured to support radio waves in the frequency band (second frequency band) for telematics, and resonates in the radio wave frequency band (first frequency band) supported by the patch antenna 30 (first antenna).

Here, using a vehicular antenna device 80X according to a comparative example which will be described later, a description will be given of comparison between characteristics of the patch antenna 30 in the vehicular antenna device 80X and characteristics of the patch antenna 30 in the vehicular antenna device 80C according to a third example of an embodiment of the present disclosure.

### Configuration of Vehicular Antenna Device 80X of Comparative Example

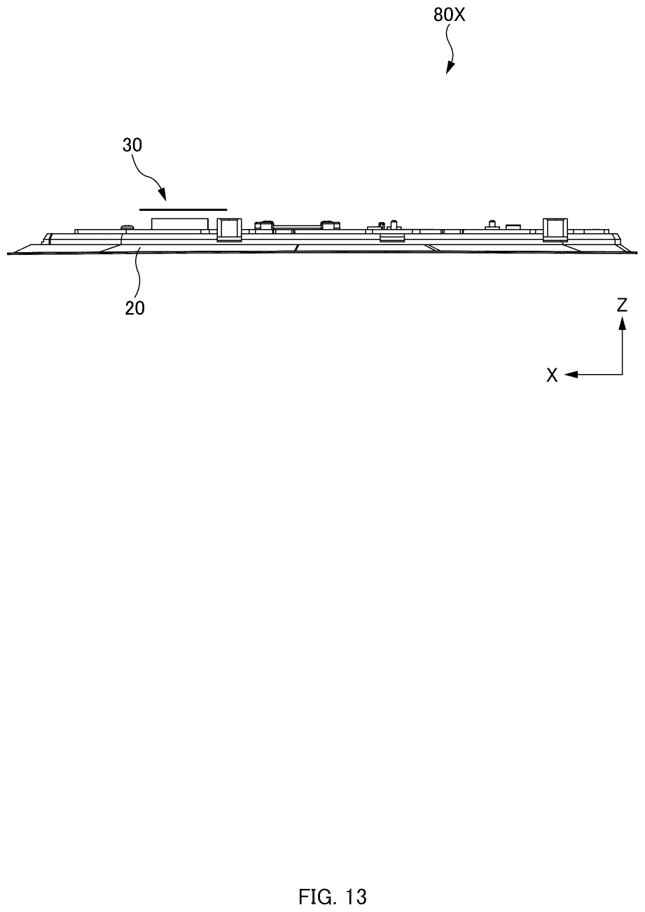

FIG. 13 is a diagram illustrating a configuration of the vehicular antenna device 80X according to the comparative example. As illustrated in FIG. 13, the vehicular antenna device 80X is a vehicular antenna device including only the patch antenna 30. Thus, in the following description, the vehicular antenna device 80X may be referred to as “patch antenna stand-alone model”.

In other words, the vehicular antenna device 80X is a vehicular antenna device obtained by removing the antenna 33C from the vehicular antenna device 80C described above. The vehicular antenna device 80X has the same configuration as that of the vehicular antenna device 80C according to the third example of an embodiment of the present disclosure described above, except that no antenna 33C is provided.

### Comparison of Characteristics Between Vehicular Antenna Device 80C and Vehicular Antenna Device 80X

Hereinafter, a description will be given of the results of calculating the characteristics of the patch antenna 30 in the vehicular antenna devices 80C and 80X.

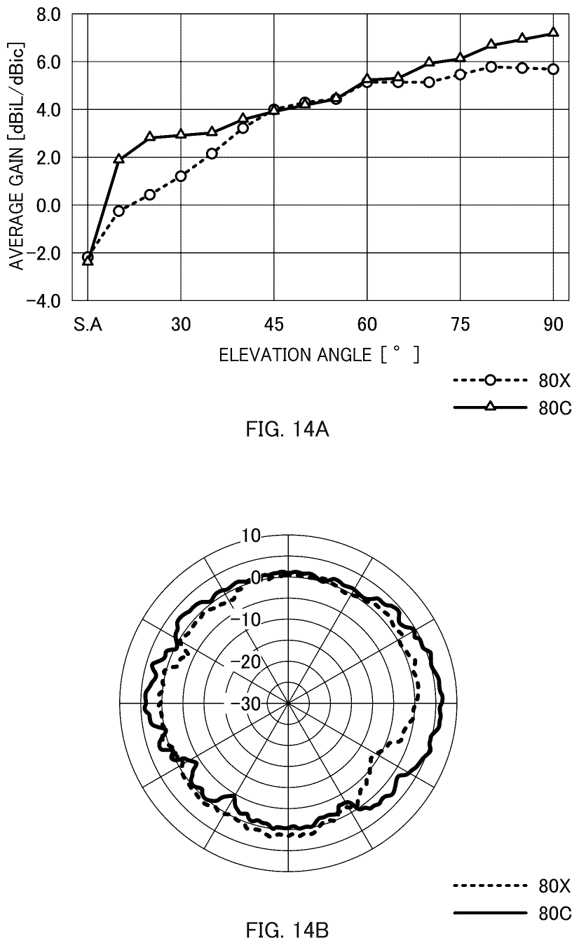

FIGS. 14A and 14B are each a graph illustrating the characteristics of the patch antenna 30 in the vehicular antenna devices 80C and 80X. FIG. 14A is a graph illustrating an example of a relationship between an elevation angle and an average gain. FIG. 14B is a graph illustrating an example of directivity at the elevation angle of 20°.

In FIG. 14A, the horizontal axis represents the elevation angle, and the vertical axis represents the average gain. In FIG. 14A, the dashed line depicts the calculation result in the vehicular antenna device 80X, and the solid line depicts the calculation result in the vehicular antenna device 80C. Circles, each given a symbol ∘, on the dashed line and triangles, each given a symbol Δ, on the solid line indicate the positions of the numerical values on the vertical axis with respect to the numerical values on the horizontal axis, and these symbols ∘ and Δ are used for convenience to differentiate therebetween. In the following description, the average gain may be simply referred to as “gain”.

As illustrated in FIGS. 14A and 14B, when comparing the gain of the vehicular antenna device 80X according to the comparative example with the gain of the vehicular antenna device 80C according to an embodiment of the present disclosure, the gain of the vehicular antenna device 80C according to an embodiment of the present disclosure is higher than the gain of the vehicular antenna device 80X according to the comparative example particularly within the range of the low elevation angle. Accordingly, as an antenna device to receive radio waves transmitted from a satellite, for example, the vehicular antenna device 80C according to an embodiment of the present disclosure has the average gain improved within at least part of the range of the elevation angle from the low elevation angle to the middle elevation angle of the patch antenna 30, resulting in having ideal directivity.

Accordingly, as a result of improving the directivity of the patch antenna 30 in the vehicular antenna device 80C according to an embodiment of the present disclosure, it is possible to efficiently receive incoming radio waves from a satellite, for example. As such, the vehicular antenna device 80C according to an embodiment of the present disclosure can easily control the directivity of the patch antenna 30, by including the resonator 91. Although detailed description of the verification is omitted, the vehicular antenna devices 80A and 80B described above can also easily control the directivity of the patch antenna 30, by including the resonator 91.

Here, in the side views illustrated in FIGS. 11B, 12A, and 12B, the patch antenna 30 and the resonator 91 in the vehicular antenna devices 80A to 80C according to an embodiment of the present disclosure are nonoverlapping. Further in a top view, although not illustrated, the patch antenna 30 and the resonator 91 in the vehicular antenna devices 80A to 80C according to an embodiment of the present disclosure are nonoverlapping.

As in the case of the vehicular antenna device 10 according to the first embodiment described above, in the vehicular antenna devices 80A to 80C according to an embodiment of the present disclosure as well, the patch antenna 30 and the resonator 91 are separated by a predetermined distance in the horizontal direction or the vertical direction. In this event, the phase of the radio waves supported by the patch antenna 30 and the phase of the radio waves supported by the antennas 33A to 33C each including the resonator 91 strengthen each other. The following verifies the separation distance at which the phase of the radio waves supported by the patch antenna 30 and the phase of the radio waves supported by the antenna 33C among the antennas 33A to 33C strengthen each other.

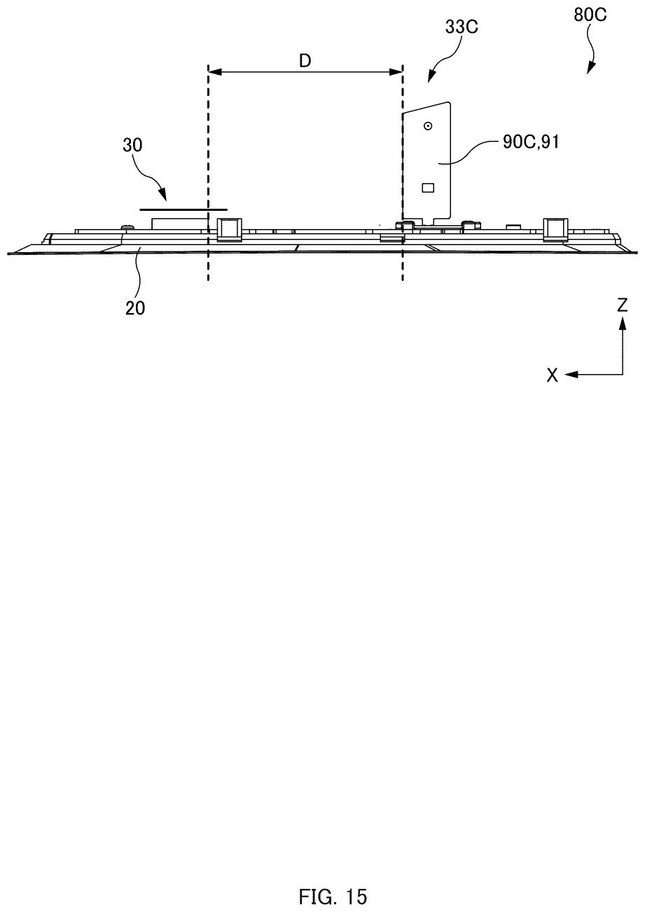

FIG. 15 is an explanatory diagram of a separation distance D between the patch antenna 30 and the resonator 91.

The separation distance D is a separation distance in the horizontal direction (X direction) between the patch antenna 30 and the resonator 91 of the antenna 33C in the side view as illustrated in FIG. 15. To be more specific, the separation distance D is the distance between the end of the patch antenna 30 closest to the resonator 91 and the end of the resonator 91 closest to the patch antenna 30, in the horizontal direction.

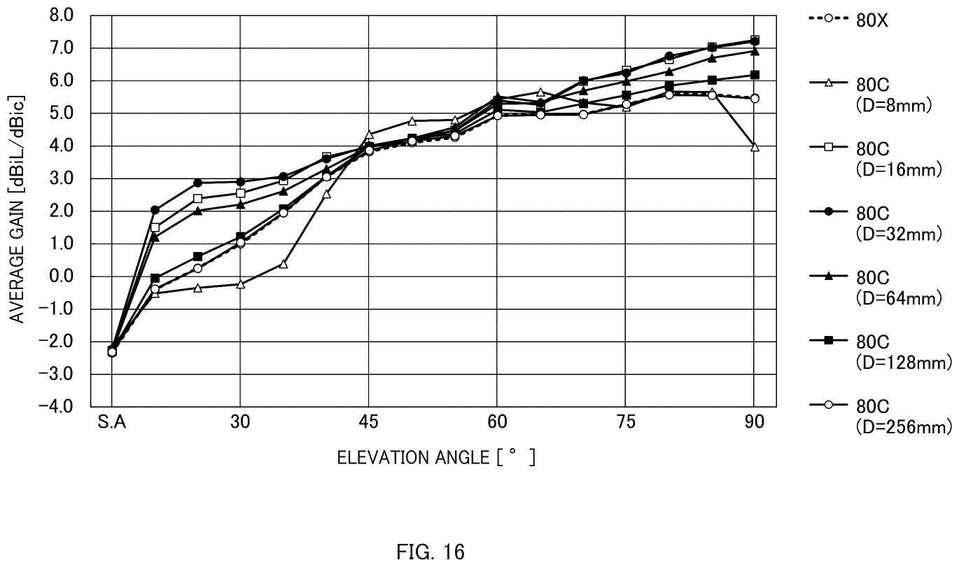

FIG. 16 is a graph illustrating an example of a relationship between an elevation angle and an average gain when the separation distance D is changed.

In FIG. 16, the horizontal axis represents the elevation angle, and the vertical axis represents the average gain. In FIG. 16, the dashed line depicts the calculation result in the vehicular antenna device 80X according to the comparative example, and a plurality of solid lines depict the calculation results in the vehicular antenna device 80C according to an embodiment of the present disclosure when the separation distance D is changed. Here, triangles, each given a symbol such as A, squares, each given a symbol such as Q, and the like on the solid lines indicate the calculation results when the separation distance D is changed to 8 mm, 16 mm, 32 mm, 64 mm, 128 mm, and 256 mm. These symbols, such as A, Q, and the like, on the solid lines indicate the positions of the numerical values on the vertical axis with respect to the numerical values on the horizontal axis, and these symbols such as A, Q, and the like are used for convenience to differentiate thereamong. In the following description, the average gain may be simply referred to as “gain”.

As illustrated in FIG. 16, when the separation distance D is 8 mm, the gain of the vehicular antenna device 80C is lower than the gain of the vehicular antenna device 80X (patch antenna stand-alone model given the symbol ∘) especially in the range of the low elevation angle. Meanwhile, when the separation distance D is 16 mm, 32 mm, 64 mm, 128 mm, and 256 mm, the gain of the vehicular antenna device 80C is higher than the gain of the vehicular antenna device 80X (patch antenna stand-alone model given the symbol ∘) at least in the range of the low elevation angle.

From this, it can be seen that when the separation distance D is equal to or more than 16 mm, the characteristics of the patch antenna 30 of the vehicular antenna device 80C are improved more than those of the patch antenna stand-alone model. Here, 16 mm corresponds to ⅛ of the wavelength of the radio wave frequency band (first frequency band) supported by the patch antenna 30 (first antenna). Accordingly, in the vehicular antenna device 80C according to an embodiment of the present disclosure, it is preferable that the first antenna (patch antenna 30) and the resonator 91 are separated in the horizontal direction by a distance equal to or more than ⅛ of the wavelength of the first frequency band.

As illustrated in FIG. 16, when the separation distance D is 128 mm, the gain of the vehicular antenna device 80C is slightly higher than the gain of the vehicular antenna device 80X (patch antenna stand-alone model given the symbol ∘). However, when the separation distance D is 256 mm, the graph of the vehicular antenna device 80C and the graph of the vehicular antenna device 80X (patch antenna stand-alone model) substantially match. That is, it can be seen that when the separation distance D is 256 mm, the gain of the vehicular antenna device 80C is approximately the same as the gain of the vehicular antenna device 80X (patch antenna stand-alone model).

Accordingly, when the separation distance D is greater than 128 mm, the characteristics of the patch antenna 30 of the vehicular antenna device 80C are approximately the same as those of the patch antenna stand-alone model. Here, 128 mm corresponds to one wavelength in the radio wave frequency band (first frequency band) supported by the patch antenna 30 (first antenna). Accordingly, in the vehicular antenna device 80C according to an embodiment of the present disclosure, by setting the horizontal separation distance between the first antenna (patch antenna 30) and the resonator 91 to one wavelength in the first frequency band or less, the characteristics of the patch antenna 30 are improved, which is particularly advantageous.

### Other

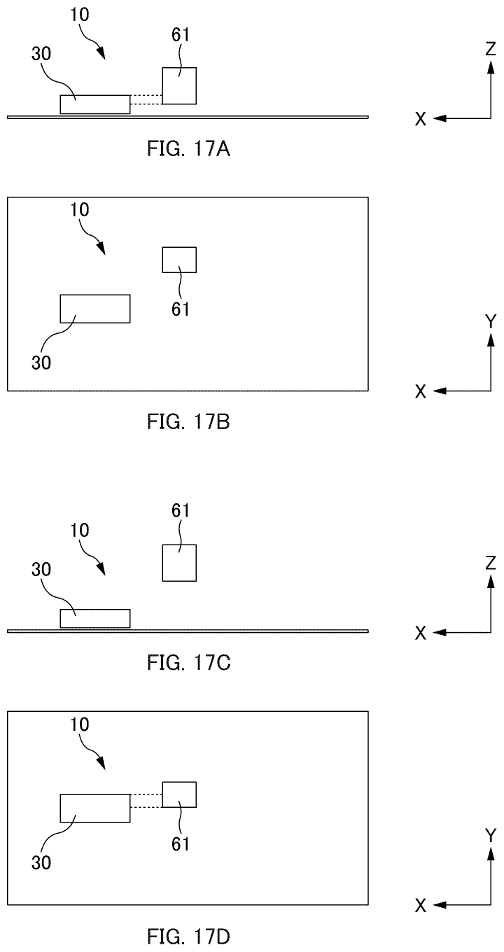

FIGS. 17A to 17D are diagrams illustrating other examples of the positional relationship between the patch antenna 30 and the resonator 61. FIGS. 17A and 17B are a side view and a plan view illustrating a first example of the positional relationship, respectively. FIGS. 17C and 17D are a side view and a plan view illustrating the second example of the positional relationship, respectively.

In the vehicular antenna device 10 illustrated in FIG. 1 described above, the patch antenna 30 and the resonator 61 are nonoverlapping in the top view and side view. However, it is not needed that the patch antenna 30 and the resonator 61 are nonoverlapping in both the top view and the side view, and the patch antenna 30 and the resonator 61 may be nonoverlapping in either the top view or the side view.

In the first example of the positional relationship, the patch antenna 30 and the resonator 61 overlap each other in the side view illustrated in FIG. 17A. However, in the top view illustrated in FIG. 17B, the patch antenna 30 and the resonator 61 are nonoverlapping. The dashed lines depicted in FIG. 17A are auxiliary lines to depict that the patch antenna 30 and the resonator 61 overlap each other.

In the second example of the positional relationship, the patch antenna 30 and the resonator 61 are nonoverlapping in the side view depicted in FIG. 17C, while the patch antenna 30 and the resonator 61 overlap each other in the top view depicted in FIG. 17D. The dashed lines depicted in FIG. 17C are auxiliary lines to indicate that the patch antenna 30 and the resonator 61 overlap each other.

The directivity of the patch antenna 30 can be more easily controlled even when the patch antenna 30 and the resonator 61 are nonoverlapping in either the top view or the side view, as in the first and second examples of the positional relationship.

### Summary

The vehicular antenna device 10 according to an embodiment of the present disclosure has been described above. As illustrated in FIG. 1, for example, the vehicular antenna device 10 includes the patch antenna 30 (first antenna) configured to support radio waves in the 2.3 GHz band (first frequency band) for SDARS, for example, and the antenna 32 (second antenna) configured to support radio waves in the 522 kHz to 1710 kHz band for AM broadcasting and 76 MHz to 108 MHz band for FM broadcasting (second frequency band), for example, which is different from the first frequency band. At least part (for example, the metal body 60A) of the element (for example, the capacitive loading element 60) included in the second antenna resonates in the first frequency band. According to the vehicular antenna device 10 of an embodiment of the present disclosure, it is possible to easily control the directivity of a planar antenna (for example, the patch antenna 30).

Further, the vehicular antenna devices 80A to 80C according to an embodiment of the present disclosure have been described. As illustrated in FIGS. 11A, 11B, 12A, and 12B, for example, the vehicular antenna device 80A, 80B, 80C includes the patch antenna 30 (first antenna) configured to support radio waves in the 2.3 GHz band (first frequency band) for SDARS, for example, and the antenna 33A, 33B, 33C (second antenna) configured to support radio waves in the frequency band for telematics (second frequency band), for example, which is different from the first frequency band. At least part of the element (for example, the element 90A, 90B, 90C) included in the second antenna resonates in the first frequency band. According to the vehicular antenna devices 80A to 80C of an embodiment of the present disclosure, it is possible to easily control the directivity of the planar antenna (for example, the patch antenna 30).

At least part (for example, the metal body 60A) of the element (for example, the capacitive loading element 60) includes the resonator 61 formed to have an electrical length to resonate in the first frequency band, as illustrated in FIGS. 3, 8, 9, and 10, for example. This makes it possible to easily control the directivity of the planar antenna (for example, the patch antenna 30).

Further, the electrical length of the resonator 61 is ½ of the wavelength of the first frequency band. This makes it possible to easily control the directivity of the planar antenna (for example, the patch antenna 30).

The resonator 61 includes at least one turn 64 as illustrated in FIGS. 3, 8, 9, and 10, for example. Thus, the resonator 61 can be formed to have the electrical length to resonate in the first frequency band.

As illustrated in FIGS. 3, 8, 9, and 10, for example, the resonator 61 has a gap (the slit 62 or the slot 63) formed therein, the gap extending in at least either the horizontal direction or the vertical direction. Thus, the resonator 61 can be formed to have an electrical length to resonate in the first frequency band.

The resonator 61 is formed by repeating a turn in the horizontal direction, as illustrated in FIGS. 3, 8B, 9A, and 10A, for example. Thus, the resonator 61 can be formed to have an electrical length to resonate in the first frequency band.

As illustrated in FIGS. 1 and 6, for example, the patch antenna 30 (first antenna) and the resonator 61 are nonoverlapping in the top view and the side view. This makes it possible to control the directivity of the planar antenna (for example, the patch antenna 30) more easily.

As illustrated in FIGS. 17A to 17D, for example, the patch antenna 30 (first antenna) and the resonator 61 are nonoverlapping in the top view or the side view. This makes it possible to control the directivity of the planar antenna (for example, the patch antenna 30) more easily.

Further, the patch antenna 30 (first antenna) and the resonator 61 are separated by a predetermined distance in the horizontal direction or the vertical direction, as illustrated in FIGS. 1 and 6, for example. This makes it possible to control the directivity of the planar antenna (for example, the patch antenna 30) more easily.

The predetermined distance is equal to or more than ¼ of the wavelength of the first frequency band. This makes it possible to control the directivity of the planar antenna (for example, the patch antenna 30) more easily.

The second frequency band is lower than the first frequency band. This makes it possible to easily control the directivity of the planar antenna (for example, the patch antenna 30).

In an embodiment of the present disclosures, the term “vehicular” means being mountable to a vehicle. Thus, it is not limited to one mounted to a vehicle, but also includes one to be brought into a vehicle to be used in the vehicle. Further, it is assumed that the antenna device according to an embodiment of the present disclosure is used for a “vehicle” that is a vehicle provided with wheels, however, it is not limited thereto and, for example, the antenna device may be used for a movable body such as a flight vehicle including a drone and the like, a probe vehicle, a construction machinery, an agricultural machinery, a vessel, and the like without wheels.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

### REFERENCE SIGNS LIST

10, 10X, 80A to 80C, 80X vehicular antenna device
20 antenna base
21, 22 metal base
23 case
30 patch antenna (first antenna)
31 patch antenna
32 antenna (second antenna)
33A to 33C antenna (second antenna)
40 holder
41 post part
42 mounting part
50 helical element (coil)
60 capacitive loading element
60A to 60D metal body
61 resonator
62 slit
63 slot
64 turn
70 substrate
71 pattern
72 dielectric member
73 radiating element
74 holding member
74A to 74C protruding portion
75 metal body
75A to 75C recessed portion
76 through-hole
77 feed line
78 feed point
90A to 90C element
91 resonator
92 slit
93 turn
100 filter

1. A vehicular antenna device comprising:
a first antenna configured to support radio waves in a first frequency band; and
a second antenna configured to support radio waves in a second frequency band different from the first frequency band, wherein
at least part of an element included in the second antenna resonates in the first frequency band.

2. The vehicular antenna device according to claim 1, wherein
the at least part of the element includes a resonator formed to have an electrical length to resonate in the first frequency band.

3. The vehicular antenna device according to claim 2, wherein
the electrical length of the resonator is ½ of a wavelength of the first frequency band.

4. The vehicular antenna device according to claim 2, wherein
the resonator includes at least one turn.

5. The vehicular antenna device according to claim 2, wherein
the resonator has a gap formed therein, the gap extending in at least either a horizontal direction or a vertical direction.

6. The vehicular antenna device according to claim 5, wherein
the resonator is formed by repeating a turn in the horizontal direction.

7. The vehicular antenna device according to claim 2, wherein
in a top view and a side view, the first antenna and the resonator are nonoverlapping.

8. The vehicular antenna device according to claim 2, wherein
in a top view or a side view, the first antenna and the resonator are nonoverlapping.

9. The vehicular antenna device according to claim 2, wherein
the first antenna and the resonator are separated by a predetermined distance in a horizontal direction or a vertical direction.

10. The vehicular antenna device according to claim 9, wherein
the predetermined distance is equal to or more than ¼ of a wavelength of the first frequency band.

11. The vehicular antenna device according to claim 1, wherein
the second frequency band is lower than the first frequency band.
